(19) United States
(12) Patent Application Publication
(10) Pub. No.: US 2019/0118660 A1
(43) Pub. Date: Apr. 25, 2019

(54) ELECTRIC VEHICLE AND SYSTEM WITH CARBON-CAPTURE SYSTEM AND REPLACEABLE ANODES

(71) Applicant: Ben-Ami Lev Shafer-Sull, New York, NY (US)

(72) Inventor: Ben-Ami Lev Shafer-Sull, New York, NY (US)

(21) Appl. No.: 16/167,790

(22) Filed: Oct. 23, 2018

Related U.S. Application Data
(60) Provisional application No. 62/575,726, filed on Oct. 23, 2017.

(51) Int. Cl. B60L 11/18

(52) U.S. Cl. CPC B60L 11/1809; B60Y 2200/91; B60L 11/1851

(57) ABSTRACT

An electric vehicle or system generates its own power using a plurality of electrochemical cells that make up the vehicle's battery as well as a system for modifying an existing electric vehicle to be carbon-negative. Examples of the form the electric vehicle could take include a truck, a bus, a car, and a motorcycle. The system provides optimal operating conditions for electrochemical cells in the vehicle's battery to produce electricity via a chemical reaction of the metal in the electrochemical cells with air drawn from outside the vehicle. The vehicle/system features a passive mechanism for concentrating and storing carbon dioxide from the air and subsequently releasing the stored carbon dioxide in concentrated form for use in the cells' cathodes. By generating its own electricity using an onboard chemical process, the vehicle/system represents a revolution in electric vehicle technology by rendering the electric-vehicle charging station obsolete and eliminating range concerns and charge-time anxiety.

### BACKGROUND

Electric vehicles need to be plugged into a stationary power station to charge their batteries. The electricity that powers the stations is in many cases generated by burning fossil fuels, which means that the batteries in the electric vehicles are often powered by the fossil fuels they would like to void. The few proposed electric vehicles that feature metal-air batteries are typically carbon neutral, meaning that they produce no net carbon dioxide. These solutions, however, do not remove carbon dioxide from the atmosphere. On top of this, the limited driving range of currently available plug-in electric vehicles has hampered their progress and hindered large-scale adoption of the technology. Moreover, modern infrastructure poses a significant challenge to large-scale adoption of plug-in electric vehicle technology. Furthermore, today's prospective electric vehicle buyer may brave the inconvenience of charge time anxiety. Without a complete overhaul of modern infrastructure, plug-in electric vehicles may not be able to capitalize on the significant interest from the public.

### SUMMARY OF THE EMBODIMENTS

The present invention is both a standalone electric vehicle that generates its own power using a plurality of electrochemical cells, which make up the vehicle's battery as well as a system for modifying an existing electric vehicle to be carbon-negative. Examples of the form the electric vehicle could take include—but are not limited to—a truck, a bus, a car, and a motorcycle. The system provides optimal operating conditions for electrochemical cells in the vehicle's battery to produce electricity via a chemical reaction of the metal in the electrochemical cells with air drawn from outside the vehicle. The vehicle/system features a passive mechanism for concentrating and storing carbon dioxide from the air and subsequently releasing the stored carbon dioxide in concentrated form for use in the cells' cathodes. By generating its own electricity using an onboard chemical process, the present invention represents a revolution in electric vehicle technology by rendering the electric-vehicle charging station obsolete and eliminating range concerns and charge-time anxiety.

### BRIEF DESCRIPTION OF THE DRAWINGS

FIG. 1 depicts a general view of a vehicle body, which can be any vehicle, as well as a cutaway view of the same vehicle body revealing one possible embodiment of the air intake system.

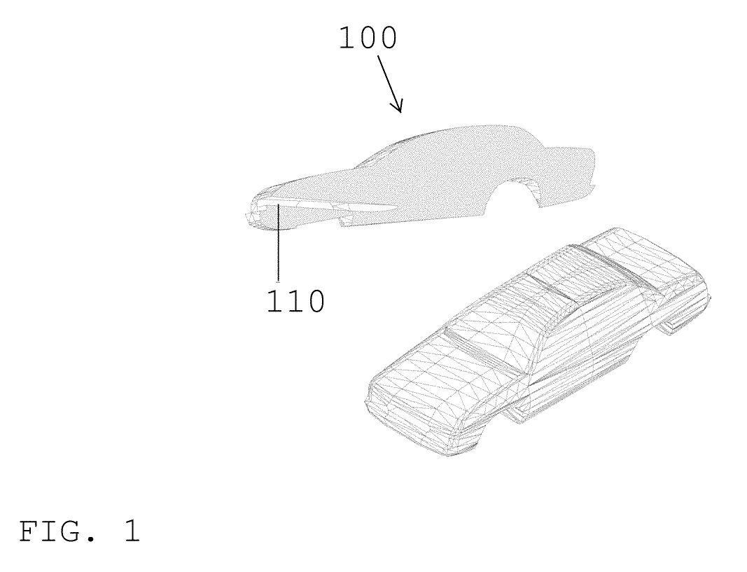

FIG. 2 shows an overview of one potential method for the gas separation process as well as an overview of the electricity generation process from gas collection to electricity production.

FIG. 3 shows a turbine that can be used for generating electricity to compress gases.

FIG. 4 shows an overview of another potential method for the gas separation process.

FIG. 5 shows one subunit of the cathode component of the Electricity Generation Complex (referred to as a “cathode subunit”).

FIG. 6 shows one “cathode unit” of the Electricity Generation Complex from various different viewpoints. (Note that the piece depicted in FIG. 5 includes multiple of the components shown in FIG. 4 connected to a rectangular base.)

FIG. 7 shows one “anode unit” of the Electricity Generation Complex from various different viewpoints.

FIG. 8 shows how one anode unit and one cathode unit may fit together with several views including a cutaway/section view of the unit formed by an anode unit and a cathode unit. Part b is the cathode unit. Part c is the anode unit Part d is an anode subunit. Part e is a cathode subunit.

FIG. 9 shows the carbon purification step of the carbon-capture process.

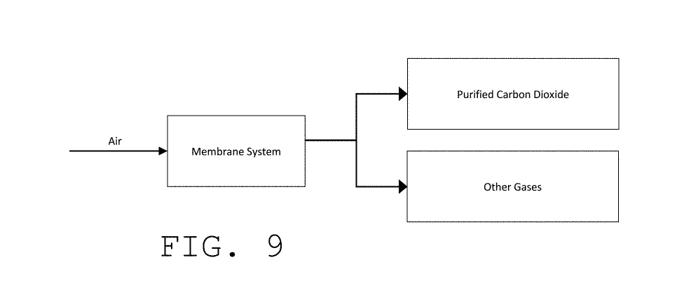

### DETAILED DESCRIPTION OF THE EMBODIMENTS

1. Electricity Generation Complex

1.1 Carbon-Capture System

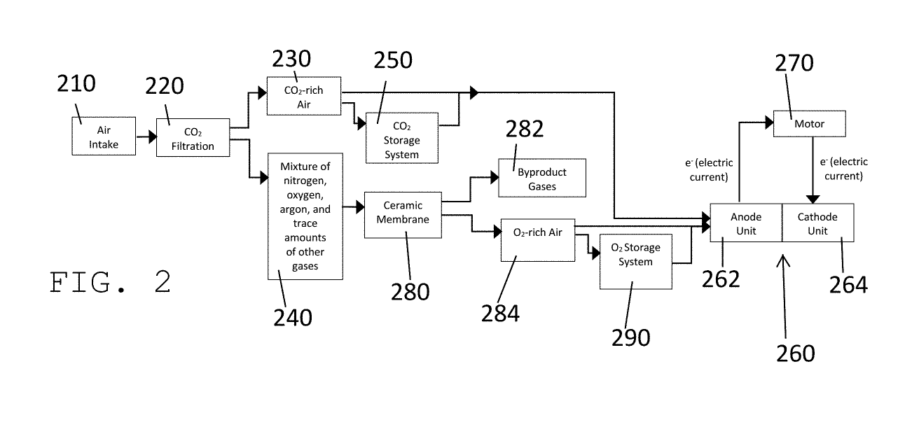

The gas separation method included in FIG. 2 is only one method for gas separation. Other methods of gas separation and carbon capture could be substituted into the method without changing the overall function of the system. Also note that FIG. 2 does not include a method for electricity storage. An electricity storage system, however, could be included.

From the system, the air intake 210 is filtered in a carbon dioxide filtration step 220 into CO2 rich air 230 and a mixture of other gases 240. The CO2 rich air may be partially stored in a CO2 storage system 250 for later delivery or delivered directly to a battery 260 with an anode 262 and cathode 264. The anode 262 feeds electricity to a vehicle motor 270, which in turn returns current to the cathode 264. The mixture of gases 240 may be further separated through a ceramic membrane 280 into the byproduct gases 282 and oxygen-rich air 284. The oxygen-rich air 284 may be fed directly to, or via an oxygen storage device 290 to the battery 260.

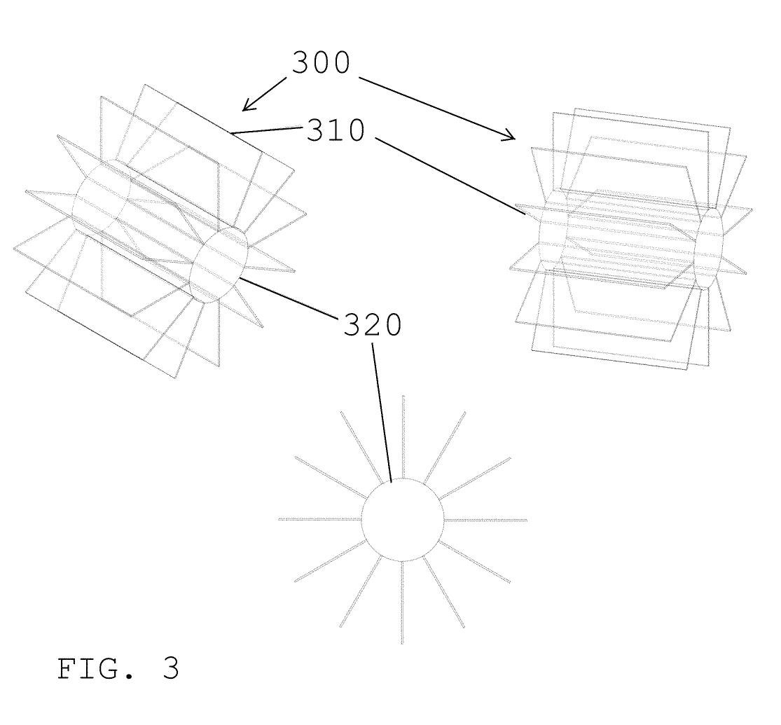

Following the system in FIG. 2, the vehicle 100 may feature a passive system for capturing and storing carbon dioxide to be used—in part—to power the car. The Carbon- Capture system comprises the air intake system 110 that may include a spiral-wound membrane, hollow-fiber membrane or other membrane system (for purification of carbon dioxide and creating a carbon dioxide-rich environment), and a storage container for the purified carbon dioxide. The purified carbon dioxide may be compressed in order to store a larger molar quantity of carbon dioxide in a smaller space using an air compressor powered by a small wind turbine 300 (FIG. 3) that is turned by the force of the oncoming air hitting the front of the vehicle. In this miniature wind turbine 300, a blade 310 extends from a rotor 320 that may be constructed using metal, plastic, carbon fiber, fiberglass, or other materials, while the rotor 320 is preferably made from metal. The mention of these systems does not preclude the use of other methods for carbon capture, purification, and storage. For instance, an alternative implementation of this system may include a small lithium-ion battery that powers a standard air compressor to compress the purified carbon dioxide. The overall process of carbon capture and subsequent used by this mode is outlined in FIG. 2. The carbon dioxide storage method for this carbon-capture configuration is described in more detail in Section 4.

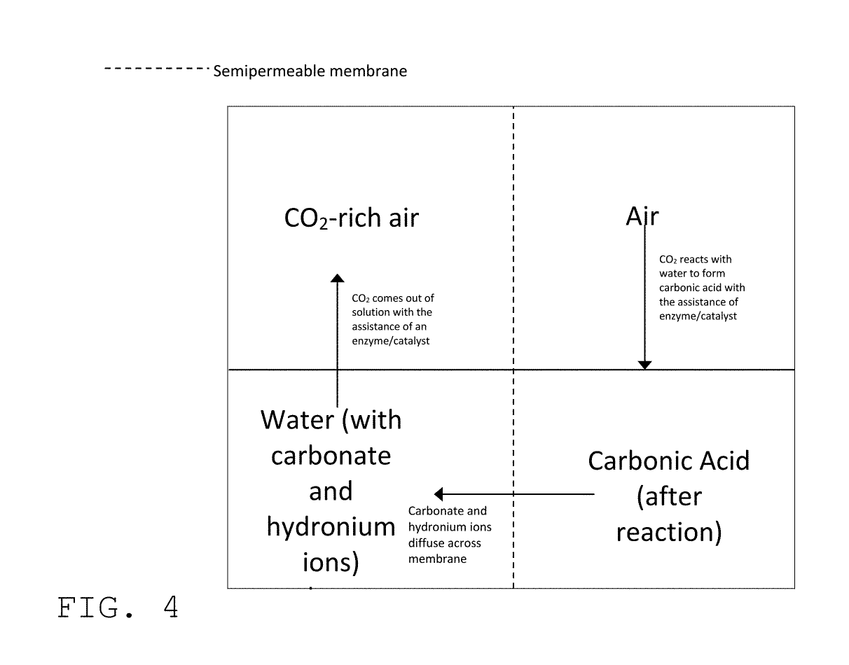

The carbon dioxide may be stored in the form of carbonic acid. This passive system comprises of two chambers: one to hold water and the other to hold carbonic acid and is shown in graphical form in FIG. 4. The chambers are separated by a semipermeable membrane designed to keep the pH of the water chamber as close to neutral as possible and keep the pH of the acid chamber as close to zero as possible. This semipermeable membrane can be made out of any number of materials, including—but not limited to—a perfluorosulfonic acid/polytetrafluoroethylene copolymer. The reaction between water and carbon dioxide to form carbonic acid is facilitated either by the enzyme carbonic anhydrase, a synthetic version of the enzyme carbonic anhydrase, or something similar to a synthetic version of carbonic anhydrase. The air containing carbon dioxide is fed to the water chamber by a system of tubes leading through the vehicle from the vents in the vehicle's grille. These tubes channel the air from outside of the vehicle into the water chamber. These tubes can be made out of any number of materials, one of which is rubber.

1.2 Oxygen Purification System

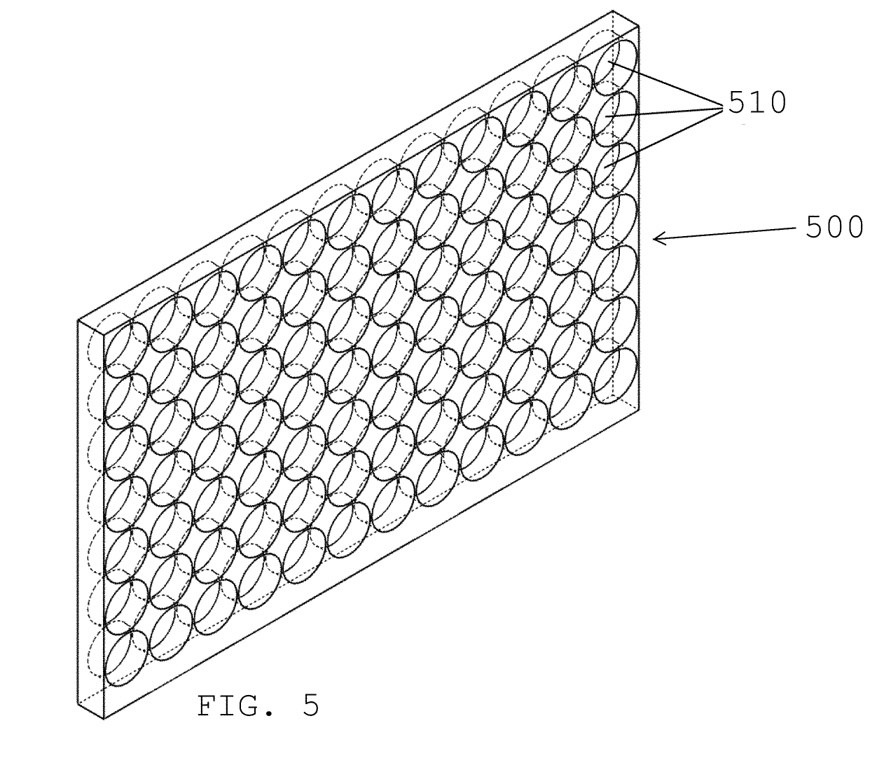

The electrochemical cells that power the vehicle also uses oxygen. In order to use this oxygen, it may be separated from the other components of air. To separate oxygen from the other components of air, the oxygen purification system may use ceramic membrane technology. After oxygen purification, the oxygen may either be transported to a storage container and compressed using the air compression mechanism described in section a or transported to the Electricity Production System via a system of small tubes. If the vehicle is configured with a Primary Electricity Storage System, then the oxygen may be transported to a storage container and compressed. Potential materials for the oxygen storage container include, but are not limited to, aluminum and steel. The oxygen can be transported from its storage container through a network of tubes leading from the storage container to the Electricity Production System. The ends of the tubes are connected with airtight seals to cylindrical channels that lead through the cathode subunits 500 shown in FIG. 5 (oxygen transport tubes and channels not pictured). The carbon dioxide may thereby be able to reach each anode within every anode subunit. This description is not meant to be limiting; it is meant only to give an example of one possible mode of oxygen transport. If the vehicle is not configured with a Primary Electricity Storage System, then the oxygen may be transported directly to the Electricity Production System.

Each cylindrical hole 510 in the cathode subunit 500 contains the cathode of one electrochemical cell and may also contain the electrolyte and separator for the electrochemical cell. Possible configurations of these electrochemical cells may be described in greater detail below.

1.3 Electricity Production System

The Electricity Production System may use a version of a metal-air electrochemical cell to produce electricity to power the vehicle. The Electricity Production System comprises a plurality of these electrochemical cells. The anodes of the electrochemical cells are made of a metal (aluminum is one example, but many other metals can be used). The cathodes comprise a mixture of gases drawn from the air outside of the vehicle as well as a thin layer of a highly electrically conductive substance (electrically conductive carbon black is one example, but many other substances can be used). The mixture of gases includes, but is not limited to, carbon dioxide, oxygen, and nitrogen. Each electrochemical cell may also have an electrolyte, which can-but does not necessarily need to-be made of an equimolar chlorine/aluminum chloride melt. Each electrochemical cell may also have a separator. The electricity production system can send electricity to three places: 1) Directly to the inverter; in this case the Electricity

Production System takes the place of the traditional electric vehicle battery 2) (Optionally) To the Primary Electricity Storage system, which can be a rechargeable lithium-ion battery or another type of electricity storage mechanism; in this case, the Electricity Production System produces electricity to charge the Primary Electricity Storage System, and the Primary Electricity Storage System is discharged to power the vehicle 3) (optionally) to the Backup Electricity Storage System. One possible layout of the electrochemical cells is as follows. The electricity production system may have a plurality of thin boxes, like the one shown in FIG. 5, spaced evenly. These boxes can be made out of an inert material, and they may feature rows of small, cylindrical cutouts 510 like those shown in FIG. 5. Each box may have many rows of these small cylindrical cutouts. These cylindrical cutouts 510 contain the cells' cathodes or anodes as discussed in the following.

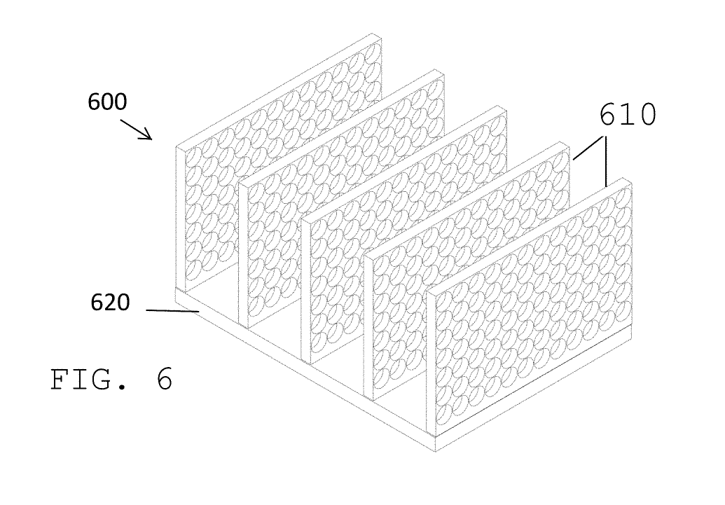

These cathode subunits 610 may be combined on a rectangular base 620 to form a cathode unit array 600 as shown in FIG. 6. Each cathode unit array 600 may contain any number of cathode subunits 610. There may also be a complementary set of boxes featuring many rows of protruding, hollow cylinders on each box. These protruding, hollow cylinders contain the cells' anodes. These boxes may be made of an inert material and may be referred to as “anode subunits.” These anode subunits may be connected by a rectangular base made of metal or plastic or another material to form what may be referred to as “anode units.”

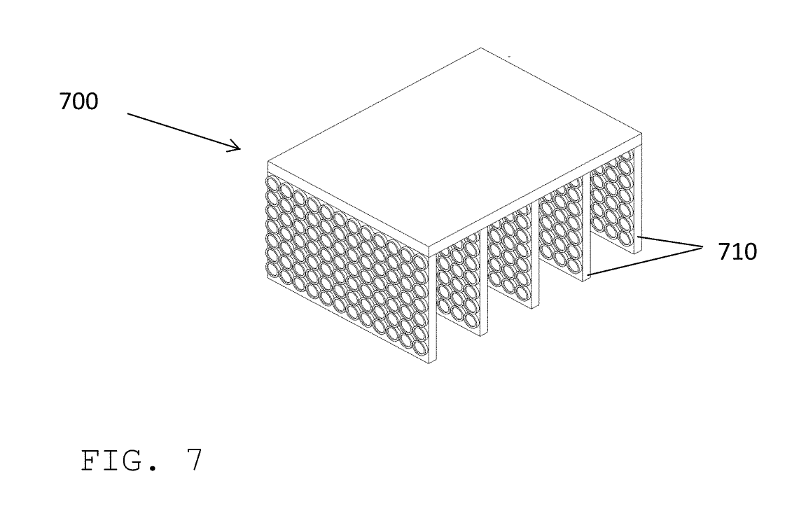

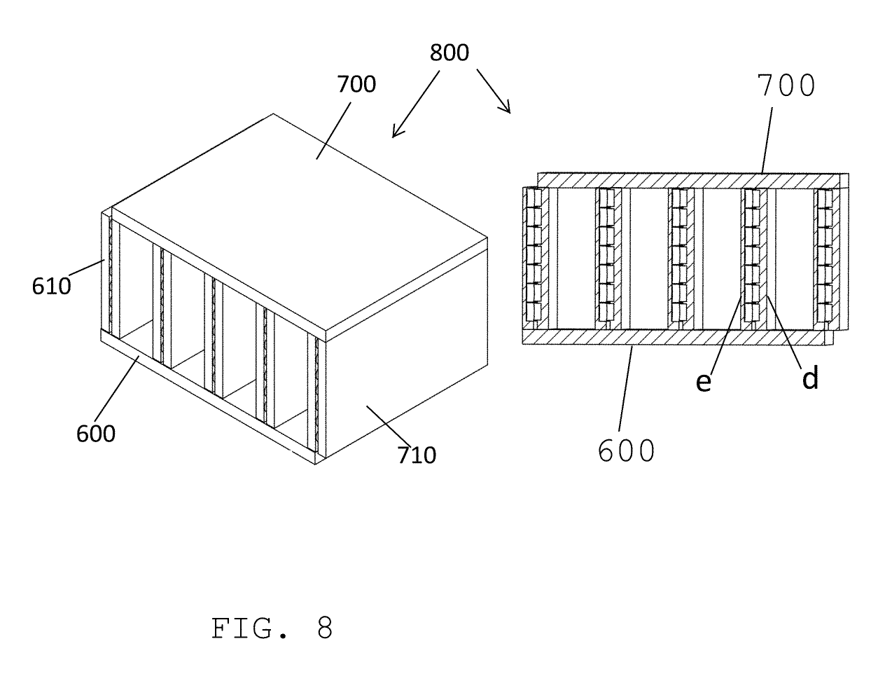

Each anode unit 700 may contain any number of anode subunits 710 as shown in FIG. 7. In order to complete each electrochemical cell, one may slide the anode unit 700 into the cathode unit 600 by aligning the anode subunits 710 with the spaces between the cathode subunits 610 and pushing the anode unit to the proper side so that the protruding cylinders of each anode subunit fit snugly inside of the cylindrical cutouts of the corresponding cathode subunit (the connection of an anode unit with a cathode unit is shown in FIG. 8). The description of this formulation is not meant to be limiting; it is simply meant to show demonstrate how the formulation at hand could be used to create an electrochemical cell that can be separated into its component parts.

Note that the anode array 700 depicted in FIG. 7 includes of multiple anode subunits 710 that are analogous and complementary to the subunits depicted in FIG. 5; the cylinders of each anode subunit 710 are designed to fit inside of the cylindrical cutouts on each cathode subunit 610. The anode unit 710 is complementary to the cathode unit 610. The anode unit 710 is identical to the cathode unit 610 except for that the anode unit 710 features protruding cylinders instead of cylindrical holes. Each protruding cylinder contains the anode of one electrochemical cell.

1.4 Anode Replenishment System

As the chemical reaction inside the electrochemical cells proceeds, the metal in the anodes may become depleted. The vehicle may contain a system for replenishing the depleted anodes. This system may be a product of the physical layout of the plurality of electrochemical cells making up the battery. As mentioned in the description of the Electricity Production System, each electrochemical cell comprises of two parts. In order to complete each electrochemical cell, the module containing the anodes may be inserted between two of the modules containing the cathodes and subsequently pushed in the proper direction to make the protruding cylinders housing the anodes fit inside of the cylindrical cutouts housing the cathodes (these cylindrical cutouts are pictured in FIG. 5 as 510). This mechanism constitutes the Anode Replenishment System. Furthermore, each cathode subunit 610 may contain the electrolyte necessary to yield a complete electrochemical cell when the cathode subunit 610 is brought together with the anode subunit 710. The electrolyte in the cathode subunit could, for example, be kept in place by using a membrane constructed from a self-healing material that can be pierced by a small sharp edge of the anode subunit upon bringing the anode subunit together with the cathode subunit. Once the cathode unit 610 is removed from the vehicle, the membrane in each individual cathode subunit 610 may heal itself, resealing the electrolyte inside of each cathode subunit 610. Thus, through this mechanism the replenishment of the electrolyte is included with the replenishment of the anode.

The interval at which the anode units 710 may be replenished is a function of how large each anode unit 710 is and how much of the anode metal is included in each anode subunit. The size of an anode unit may ideally be small enough that one person could carry the anode unit in order to insert it into the vehicle, however the size of an anode unit is theoretically only limited by the size of the vehicle. Anode units may be available for purchase individually or in packs containing multiple anode units. Each anode unit may resemble a rectangular prism in shape.

Depending on the physical location of the cathode units, replenishing the anode could comprise sliding an anode unit into a designated slot on the side of the vehicle. This description is not intended to be limiting. Rather, it is meant to give one possibility for how this system would be implemented into the vehicle.

1.5 Primary Electricity Storage System (optional)

The Primary Electricity Storage system can be implemented to facilitate a simpler mode of controlling the electrical output of the Electricity Generation Complex. The Primary Electricity Storage System may comprise a battery, such as a rechargeable lithium-ion battery, or any other type of electricity storage mechanism. The Primary Electricity Storage System may be charged by electricity from the Electricity Production System; in a configuration that includes the Primary Electricity Storage System, the Primary Electricity Storage System may be discharged to power the vehicle.

The vehicle may also feature a mechanism for charging the Primary Electricity Storage System via a traditional wired electric current

1.6 Backup Electricity Storage System

The Backup Electricity Storage System can be included as a precaution for emergency situations in which the Electricity Production System malfunctions. If included, the Backup Electricity Storage system may be charged using surplus electricity generated by the Electricity Production System as the vehicle is driven. The purpose of the Backup Electricity Storage system is to function as a last-resort to allow the vehicle to be driven to a service station in the case of malfunction. The Backup Electricity Storage system can comprise any currently available mechanism for the storage of electricity, including, but not limited to a lithium ion battery pack.

The vehicle may also feature a mechanism for charging the Backup Electricity Storage System via a traditional wired electric current

2. Inverter

In order for the Electricity Generation Complex to power the AC induction motor, the direct current produced by the Electricity Generation Complex may be converted to AC. This conversion may be handled by the inverter. The Electricity Generation Complex may have an electrode through which the generated electricity is output The inverter may be connected to this electrode by conductive wires. Any currently available inverter may suffice. This inverter may be connected to the motor using a conductive wire.

3. Motor

The motor generates the power to turn the vehicle's wheels. Any currently available electric motor, including—but not limited to—an AC induction motor, may suffice. In the case of an AC induction motor, the inverter feeds an AC current to the induction motor, which causes the rotor to spin, generating a rotating magnetic field. The rotation of the rotor turns gears in a gearbox, which turn axles. The rotation of the axles turns the wheels.

Another configuration features one motor in each of the vehicle's wheels.

4. Carbon Dioxide Storage System (if carbon dioxide is not stored in the form of carbonic acid)

After being separated from the incoming mixture of gases as shown in FIG. 2, the carbon dioxide may be compressed using electricity generated by the turbine depicted in FIG. 3 and stored within the Carbon Dioxide Storage System. This system may comprise a tank made of any material that can withstand high pressures. Potential materials for the tank include, but are not limited to, steel and aluminum. Then, when necessary, the carbon dioxide can be transported to electrochemical cells through a network of impermeable tubes. The tubes lead from the Carbon Dioxide Storage System to the cathode units. The ends of the tubes are connected with airtight seals to cylindrical channels that lead through the cathode subunits 610 depicted in FIG. 6 (carbon dioxide transport tubes and channels not pictured). The carbon dioxide may thereby be able to reach each anode within every anode subunit 710. This description is not meant to be limiting; this is only one of many possible configurations of the Carbon Dioxide Storage System. There are other ways for the carbon dioxide to be transported from the Carbon Dioxide Storage System to the Electricity Generation Complex.

5. Byproduct Storage Complex

5.1 Byproduct Harvesting Mechanism

The chemical reaction that occurs in the Electricity Generation Complex produces byproducts. Among these byproducts may be chemical compounds that are valuable for one reason or another. Through the discharge of the electrochemical cells that make up the Electricity Generation Complex these byproducts may be deposited on the electrodes of the electrochemical cells in the Electricity Generation Complex. More specifically, these byproducts may be deposited on the cathode of the electrochemical cells in the Electricity Generation Complex. The present system may feature a system/mechanism for the purposes of harvesting these deposits of chemical compounds from the electrodes of the electrochemical cells in the Electricity Generation Complex. This system could take a variety of forms. This may be done either onboard of the vehicle or by removing the cathode units from the vehicle. One possible implementation of this system involves utilizing water to force aluminum to form a precipitate because aluminum oxalate is insoluble in water. In this implementation, the aluminum oxalate could be harvested by a small, electrically-powered scraper embedded within each electrochemical cell.

Alternatively, another implementation could involve removing the entirety of the cathode unit to harvest the chemical byproducts and subsequently replacing the used cathode unit with a new cathode unit Additionally, the electrochemical cells can be split using an assembly in the cell return system or use of a piercing apparatus also in said system. The splitting mechanism can be made to disassemble the cells serially or in packs wherein the cells may be fed into and then potentially held by a suction apparatus and pulled apart, or have their tops popped off by a mechanical actuator that grips both ends of the cell. Once this is done the contents can be collected and the oxalate purified through either mechanical or chemical means depending on the structure of the cells. This can be in the form of a standalone unit or a production line housed in a closed facility. For the apparatus that punctures the cells a port on the cells may be used, or another compartment within the cells wherein the byproduct can be accumulated through gravity or an active transport system housed either within the cells or in close proximity to the cells. This system may be in the form of a centrifuge to pull the material to one side or into a specific area where it can easily access by means of a spring-loaded, lever-operated release mechanism.

5.2 Byproduct Storage

After these byproducts have been isolated, they may be stored. The present system may contain an apparatus for storing these byproducts. The apparatus may include a tank that is easily accessible from outside of the equipped vehicle. As the chemical reaction progresses, the tank fills with the valuable byproducts. The byproduct storage tank can be implemented in the vehicle in any number of ways. This storage tank is easily removable so that it can be exchanged for a new storage tank when necessary.

Another possible configuration involves integrating the Byproduct Storage Complex into the Anode Replenishment System. In this configuration, an unused anode unit may contain an empty compartment designed to store the valuable byproducts of the chemical reaction. As the chemical reaction proceeds, the valuable byproducts may accumulate and be moved into the empty compartment inside of the anode unit using the aforementioned Byproduct Harvesting Mechanism. When the operator of the vehicle removes a used anode unit, its byproduct storage tank may be filled with the valuable byproducts. Thus, exchanging a used anode unit for an unused anode unit simultaneously replenishes the anodes of the electrochemical cells and replaces a full byproduct storage tank with an empty byproduct storage tank. This description is not intended to be limiting; this is only one of many possible configurations for the Byproduct Storage Complex.

6. Battery Management System

During the operation of the any battery system the cells may be kept in optimal operating conditions. This necessitates active management of the concentrations of the aforementioned gases required for the electrochemical cells to produce electricity. The present invention may achieve this active management using an incorporated computer system. The computer would regulate the concentrations of these gases to provide the cells with the best possible conditions. This regulation may happen via a series of electronically actuated valves at different points of the air intake. By placing these electronically actuated valves at after the various gas purification steps, the present invention may be able to precisely control and individually regulate the concentrations of the various gases utilized in the Electricity Generation Complex.

As explained above, these gases could then be transported to the Electricity Generation Complex via a network of tubes made of rubber or another relatively impermeable material. Additionally, in an implementation in which pressurized gases are stored onboard as part of the system, pressurized gas could either be supplied from an external compression system or from the onboard compression system outlined in the specifications of the present invention. In either case, the aforementioned computer system may regulate the concentrations of the individual gases utilized by the Electricity Generation Complex and botted gases may be can be controlled by controlling the output of these bottles through similar electronically actuated valves. The system may include sensors designed to detect the specific contents of the atmosphere at various points within the Electricity Generation Complex, allowing for greater precision in this task. The system may include pressure sensors, temperature sensors, a variety of gas detectors to measure the concentrations of various types of gases, voltage sensors, current sensors, and various other types of sensors for detecting any and all potential variations in atmospheric conditions. The aforementioned onboard battery management computer may use the data from these sensors to optimize battery performance. Additionally, the system may include a display through which the onboard computer can present important information to the operator of the system such as estimated operating range, amount of battery power consumed, and any other significant information about the performance of the systems.

When the system is placed under load by its operator, the needs of the cells change. Optimal system performance is attained through the use of the aforementioned atmospheric sensors coupled with additional electrical sensors such as an ammeter and voltmeter to actively predict the needs of the Electricity Generation Complex; the conditions within the Electricity Generation Complex are kept at optimal levels through the use of this system of sensors. This allows for increased power output as there may be no sagging of reagent quantities.

7. Remaining Parts of the Vehicle

All remaining parts of the vehicle can be constructed and assembled using current standard practices.

While the invention has been described with reference to the embodiments above, a person of ordinary skill in the art would understand that various changes or modifications may be made thereto without departing from the scope of the claims.

1. A self-charging battery assembly comprising:
a system for capturing carbon dioxide, wherein the carbon dioxide is subsequently concentrated and stored in the form of carbon dioxide or carbonic acid;
a system for capturing oxygen from the air and storing it in a purified form;
a network to transport the stored carbon dioxide and oxygen to electrochemical cells comprising cathodes and anodes, wherein the anodes comprise metal that is depleted as the anodes react with the cathodes; and
an electricity storage mechanism that receives electricity generated by the electrochemical cells.

2. The battery assembly of claim 1, wherein the anodes can be replenished.

3. The battery assembly of claim 1, wherein the system for capturing carbon dioxide includes a release mechanism for releasing the carbon dioxide in a concentrated form.

4. The battery assembly of claim 1, wherein the electricity is generated to power a vehicle.

5. The battery assembly of claim 1, wherein the electrochemical cells generate power from the network that includes electrically conductive carbon black in the cathodes.

6. The battery assembly of claim 1, wherein the electrochemical cells generate power from the network that includes porous, electrically conductive substance in the cathodes of the electrochemical cells featuring metal anodes.

7. A vehicle with a self-charging battery assembly comprising:
a system for capturing carbon dioxide, wherein the carbon dioxide is subsequently concentrated and stored in the form of carbon dioxide or carbonic acid;
a system for capturing oxygen from the air and storing it in a purified form;
a network to transport the stored carbon dioxide and oxygen to electrochemical cells comprising cathodes and anodes, wherein the anodes comprise metal that is depleted as the anodes react with the cathodes; and
an electricity storage mechanism that receives electricity generated by the electrochemical cells.

8. The vehicle of claim 7, wherein the anodes can be replenished.

9. The vehicle of claim 7, wherein the system for capturing carbon dioxide includes a release mechanism for releasing the carbon dioxide in a concentrated form.

10. The vehicle of claim 7, wherein the electricity is generated to power a vehicle.

11. The vehicle of claim 7, wherein the electrochemical cells generate power from the network that includes electrically conductive carbon black in the cathodes.

12. The vehicle of claim 7, wherein the electrochemical cells generate power from the network that includes porous, electrically conductive substance in the cathodes of the electrochemical cells featuring metal anodes.

13. A method for producing electrical energy for a vehicle comprising:
capturing carbon dioxide, wherein the carbon dioxide is subsequently concentrated and stored in the form of carbon dioxide or carbonic acid;
capturing oxygen from the air and storing it in a purified form;
transporting the stored carbon dioxide and oxygen to electrochemical cells comprising cathodes and anodes, wherein the anodes comprise metal that is depleted as the anodes react with the cathodes; and
receiving electricity generated by the electrochemical cells.

14. The method of claim 13, wherein the anodes can be replenished.

15. The method of claim 13, wherein the capturing carbon dioxide includes a release mechanism for releasing the carbon dioxide in a concentrated form.

16. The method of claim 13, wherein the electricity is generated to power a vehicle.

17. The method of claim 13, wherein the electrochemical cells generate power from the network that includes electrically conductive carbon black in the cathodes.

18. The method of claim 13, wherein the electrochemical cells generate power from the network that includes porous, electrically conductive substance in the cathodes of the electrochemical cells featuring metal anodes.
